(19) United States
(12) Patent Application Publication
(10) Pub. No.: US 2023/0278225 A1
(43) Pub. Date: Sep. 7, 2023

(54) Robotic Method of Repair

(71) Applicant: ABB Schweiz AG, Baden (CH)

(72) Inventor: Louis J. LePage, Warren, MI (US)

(73) Assignee: ABB Schweiz AG, Baden (CH)

(21) Appl. No.: 18/314,905

(22) Filed: May 10, 2023

Related U.S. Application Data
(63) Continuation of application No. PCT/US2020/059800, filed on Nov. 10, 2020.

(51) Int. Cl. B25J 9/16

(52) U.S. Cl. CPC B25J 9/1692; B25J 9/1653; B25J 9/1697

(57) ABSTRACT

A method of inspection and repair of a robotic operation is provided. The robotic operation preferably includes dispensing material onto a surface of a component. A camera is used to capture an image of the robotic operation and identify defects in the robotic operation in the captured image. The locations of the defects are then transformed from the image coordinate system to the robot coordinate system. The robot may then be moved to the defect locations in the robot coordinate system to repair the defects, e.g., by dispensing additional material at the defect.

### CROSS-REFERENCE TO RELATED APPLICATIONS

This patent application claims priority to International Patent Application No. PCT/US2020/059800, filed on Nov. 10, 2020, which is incorporated herein in its entirety by reference.

### FIELD OF THE DISCLOSURE

The present disclosure generally relates to The present inventions relate generally to robotic operations, and more particularly, to a robotic method of repairing a robotic operation.

### BACKGROUND OF THE INVENTION

Robots are used in a number of dispensing applications, including applying adhesives and sealants to surfaces, welding operations, and 3D printing, etc. In a typical robotic dispensing operation, material is dispensed from the robot along a path. However, it is possible that defects may occur during the dispensing application. One example of a dispensing defect is when air is present within a sealant material being dispensed. In this case, when the air reaches the dispensing nozzle, a gap can occur along the dispensed sealant path due to the air being expelled from the nozzle instead of the sealant. While it is desirable to avoid these types of defects, it may not always be possible to prevent dispensing defects due to the unpredictable nature of the materials being dispensed. Therefore, it would be desirable to provide a system that can identify defects that occur in dispensing applications and repair such defects.

### BRIEF SUMMARY OF THE INVENTION

A method of repairing robotic operations is described. The method includes capturing images of a robotic operation and identifying defects in the robotic operation. The locations of the defects are also identified in the coordinate system of the captured image. The defect locations are then transformed to the robot coordinate system. The robot may then be moved to the defect locations in the robot coordinate system in order to repair the defects. The invention may also include any other aspect described below in the written description or in the attached drawings and any combinations thereof.

### BRIEF DESCRIPTION OF THE SEVERAL VIEWS OF THE DRAWING(S)

The invention may be more fully understood by reading the following description in conjunction with the drawings.

FIG. 1 is perspective view of a robot for performing an operation on a component.

FIG. 2 is a top view of a series of beads dispensed by the robot.

FIG. 3 is a top view of a series of beads with defects.

FIG. 4 is a flow chart of a method for repairing a robotic operation.

### DETAILED DESCRIPTION OF THE INVENTION

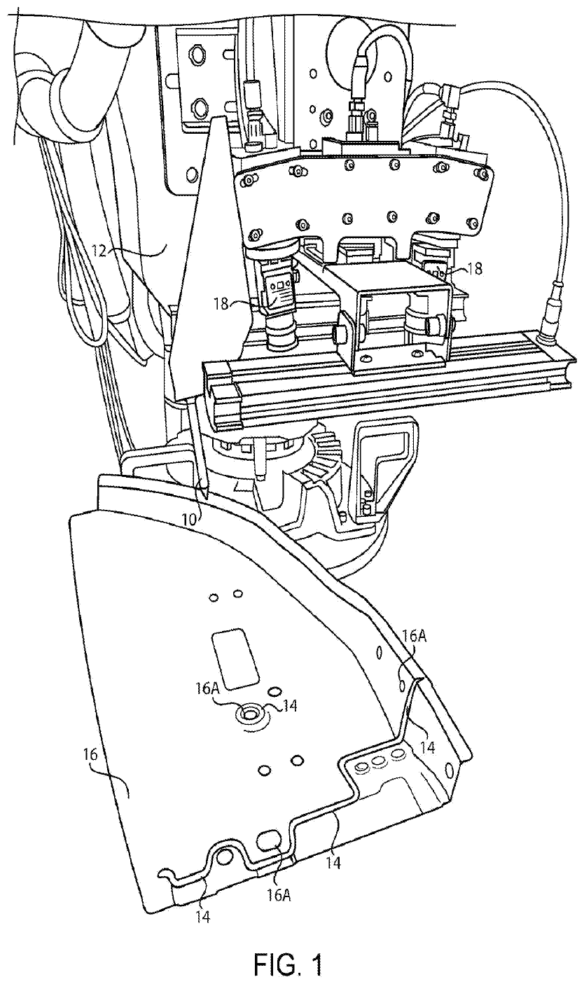

Referring now to the figures, and particularly FIG. 1, a robotic dispensing system is shown. The robotic dispensing system is provided with a dispensing nozzle 10 mounted on a robotically movable structure 12 to allow the nozzle 10 to be moved by the robot 12 in one, two or three dimensions. A controller controls movement of the robotic structure 12 and the dispensing nozzle 10 according to a desired path for material to be dispensed. In this case, the nozzle 10 may be dispensing adhesive or sealant 14 onto an assembly component 16 along a three-dimensional path 14. A variety of dispensing applications are also possible, such as welding and 3D printing. One or more cameras 18 are also provided for capturing one or more images of the dispensed material path 14. Although the camera 18 may be in a fixed location separated from the robot 12, it is preferable for the camera 18 to be movable to capture multiple images from different orientations. More preferably, the camera 18 may be mounted to the robot 12 itself such that the camera 18 is moved with the same robotic structure 12 that has the dispensing nozzle 10. Although a single camera 18 may be used, it may be preferable for two cameras 18 to be provided that use combined imagery to generate a 3D image of the dispensed material path 14. Multiple cameras 18 may also be used in different locations (e.g., a fixed location and on the robot 12). Although the camera 18 may capture images in various formats, grayscale images, point cloud data (e.g., with x, y, z and intensity attributes), etc. may be desirable.

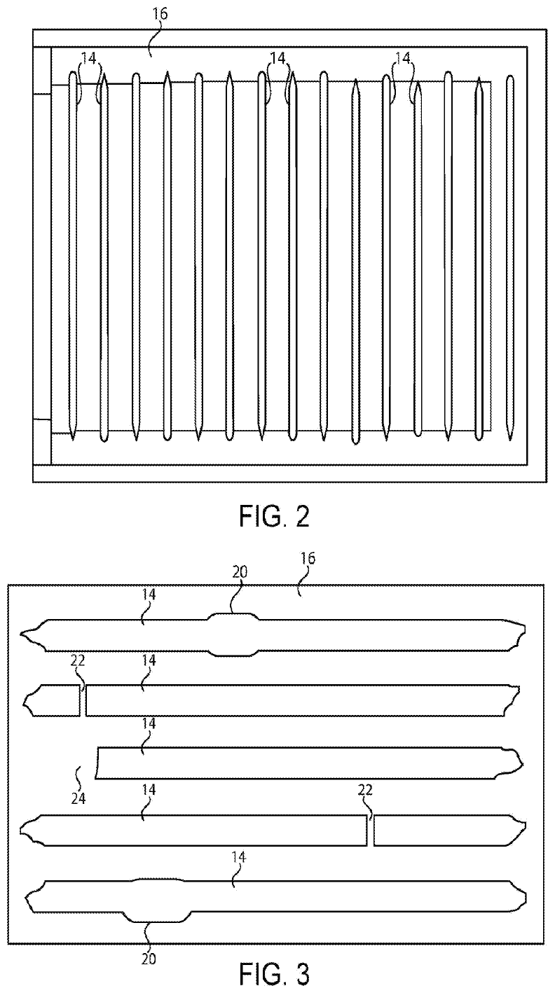

FIGS. 2 and 3 show beads 14 of material, such as an adhesive or sealant 14, that have been dispensed onto a surface. As shown, the beads 14 in FIG. 2 are generally uniform in width, with consistent starting and stopping points, and no gaps in the beads 14. By contrast, FIG. 3 shows beads 14 with sections that are wider 20 then desired, with gaps 22 in the beads 14, and a starting and stopping point that is short 24 of the desired starting or stopping point. The robotic method herein may be used to identify and repair such defects.

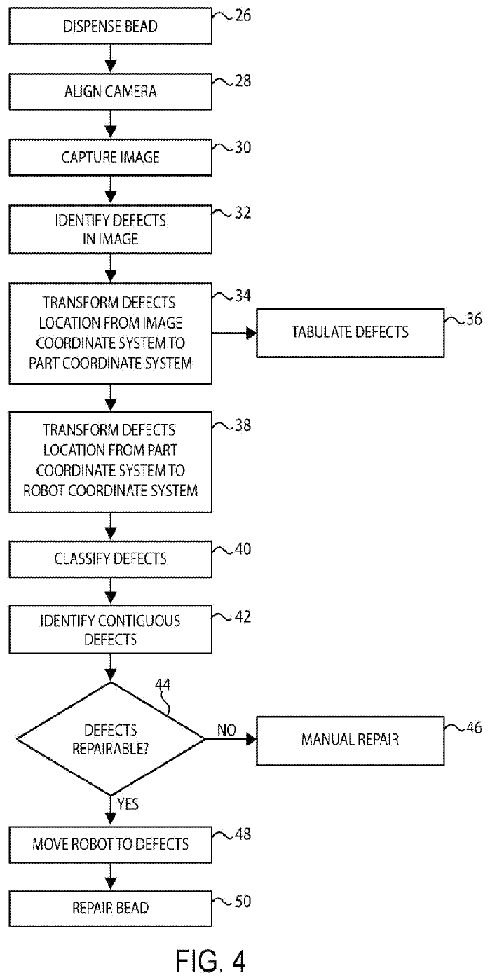

The method of inspection and repair is illustrated in the flow chart of FIG. 4. In the first step, the robotic operation is performed 26, such as dispensing a bead 14 of material on a component 16 prior to further assembly operations being done with the component 16. The camera 18 then captures one or more images of the robotic operation 30 for image analysis. Although it is possible for the camera 18 to capture images 30 as the robot 12 is performing the operation 26, it may be more desirable for the camera 18 to capture images 30 after the operation 26 is completed. For example, where the robot 12 is dispensing a bead 14 of adhesive or sealant 14 and the cameras 18 are mounted to the robot 12, it may be preferable to complete the dispensing operation 26 first and then separately move the robot 12 to various locations to capture images 30 of the dispensed bead 14. This may allow the cameras 18 to be oriented in specific locations that are best for bead 14 inspection, which would not be possible if the cameras 18 merely follow the path of the bead 14 as it is being dispensed.

Preferably, the cameras 18 are aligned 28 with the component 16 before the images are captured 30 with the cameras 18. This may be done by using one or more features 16A on the component 16 as reference points and moving the cameras 18 to a predetermined position with respect to the reference points 16A. For example, an image may be captured of the component 16 with the reference features 16A included in the image. The robot 12 may then analyze the image to determine the location of the reference features 16A in the image and move the cameras 18 to an aligned position where the reference features 16A are located at predetermined locations in the image. This may be useful in ensuring consistency in inspecting multiple components 16 of the same type, when comparing inspection images to master images, etc.

After the images have been captured 30, the robot 12 (e.g., a controller or processor connected thereto) analyzes the images to identify defects 32 in the beads 14 that have been dispensed. For example, the robot 12 may calculate the width of the bead 14 at points along the length thereof. One way to calculate the width of the bead 14 is for the robot 12 to count the number of image pixels across the bead 14 with similar contrast or color. Thus, sharp changes in pixel contrast or color while scanning across a bead 14 may indicate the edges of the bead 14. Set tolerance ranges of expected bead 14 widths (e.g., pixels) may be stored in the robot 12 for acceptable bead characteristics. The robot 12 may also be trained using machine learning techniques and images of acceptable beads 1. It is understood that the robot 12 referenced herein may include system components located away from the robot arm and moveable components thereof. For example, the robot 12 may have a vision PC or other vision processor located remotely from the robot arm that is trained using machine learning/deep learning techniques.

When identifying defects 32 in the captured images, the robot 12 may also determine whether the defects are repairable 44 by the robot 12. For example, when setting up the robotic system, it may be determined by engineers that the robot 12 should not repair an operation that has a number of defects above a threshold number. The reason for this determination may be that a high number of defects may indicate malfunctions in the robotic system that should be repaired. A high number of defects may also require more time to repair with the robotic system than a manual repair 46 would require. Other types of bead 14 defect classifications may also be used to determine repairability. If the robot determines that a dispensing operation is unrepairable 44 by the robot 12, the component 16 may be flagged and set aside for a manual repair 46 to be done to the component 16. Although the step of checking repairability 44 may be done at various points and may even be performed multiple times throughout the process, it is preferred that the repairability check 44 be done before moving the robot 48 to any of the identified defects and starting a repair 50.

When identifying defects 32 of the dispensed bead 14 in the captured images, the robot 12 also identifies the location of the defects in the image coordinate system 32 of the respective images. For example, the robot 12 may identify the pixel locations in the image where the defects are located. The defects are then transformed to the robot coordinate system 38 so that the robot 12 may be moved 48 to the defect location using the defect locations in the robot coordinate system. Preferably, the defect locations are transformed to an intermediate coordinate system (i.e., a part coordinate system) 34 between the image coordinate system 32 and the robot coordinate system 38. This may be done using reference features 16A on the component 16. Thus, in the preferred embodiment, the robot 12 identifies defects 32 in the captured image and first identifies the locations of each defect in the coordinate system of the image (e.g., using pixel locations) 32. The robot 12 then uses the location of the reference features 16A in the captured images to determine where the defects are located with respect to the component itself (i.e., the part coordinate system) 34. Finally, the robot 12 may use calibration data between the camera 18 and the robot 12 (e.g., the nozzle 10) to determine where the defects are located relative to the robot 12 (i.e., the robot coordinate system) 38.

By identifying the defect locations 32 and transforming the defect locations to the robot coordinate system 38, the robot 12 may then be moved to each of the defects 48 in the robot coordinate system to repair the defects 50. The robot 12 may repair a defect by dispensing another bead 14 of material at the location of the defect 50. For example, where the defect is a gap 22 in the bead 14, the robot 12 may move to the gap 22 and dispense another short bead 14 in the gap 22 in order to fill the gap 22. In contrast to conventional repair methods which may identify defects as the bead 14 is dispensed with timestamps identifying when the defects occurred, the preferred method herein does not need to follow the path of the original robot operation to move 48 to the defect location. Instead, because the method determines the defect locations in the robot coordinate system 38, the robot 12 is able to move directly to each defect 48 to perform the repair operation 50. This can provide substantial time savings where the bead path 14 is long and tortuous.

When repairing defects 50, it may be useful for the robot program which was used for performing the original dispensing operation to be tagged with locations associated with dispensing operation instructions. For example, a structured robot program may be used with sequential locations and associated robot instructions to be used at each location. When repairing defects 50, the robot 12 may then search the original program code to determine the robot dispensing instructions that correspond to the identified defect location and use such instructions for the repair 50. The robot instructions may include, for example, bead 14 path, bead 14 width, dispensing speed, etc. In order to make the repair operation 50 more efficient, it may also be desirable to classify the defects, which may include grouping multiple defects together 40 in a batch and sending a batch repair instruction to the robot 12 to repair the defects in one repair operation 50. This is in contrast to repairs that could be done individually one at a time where the robot 12 moves to each defect and repairs the defect 50 as defects are identified. By batching the defects 40, a single repair operation 50 may be performed, and the defect repairs may be arranged in an efficient order in the batch repair instruction (e.g., in a different order than the original dispensing operation). The locations of multiple defects may also be analyzed with respect to each other to identify defects that are next to each other in a contiguous section 42. In this situation, multiple defects may be grouped together for a single repair between the start location and the end location of the contiguous section 42. Thus, instead of repairing each individual defect separately from each other, the robot 12 may dispense a uniform bead 14 and/or follow a uniform path from the start location to the end location to repair the defects in one operation 50. By transforming the defects into the part coordinate system 34, it may also be desirable to tabulate the locations of defects from different components 36. Because the identified defects can be identified by their location on the part itself, multiple defects from multiple components (each being identified in the part coordinate system) can be compared to identify repeated defect locations. Thus, it may be determined that the robot operation repeats certain defects at specific locations on the component. As a result, engineers may use this tabulated information 36 to improve the robot operation in order to decrease the need for repair operations 50.

While preferred embodiments of the inventions have been described, it should be understood that the inventions are not so limited, and modifications may be made without departing from the inventions herein. While each embodiment described herein may refer only to certain features and may not specifically refer to every feature described with respect to other embodiments, it should be recognized that the features described herein are interchangeable unless described otherwise, even where no reference is made to a specific feature. It should also be understood that the advantages described above are not necessarily the only advantages of the inventions, and it is not necessarily expected that all of the described advantages will be achieved with every embodiment of the inventions. The scope of the inventions is defined by the appended claims, and all devices and methods that come within the meaning of the claims, either literally or by equivalence, are intended to be embraced therein.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for repairing a robotic operation, comprising:
performing an operation on a component with a robot;
capturing an image of the operation with a camera; identifying a location of a defect of the operation in an image coordinate system of the image;
transforming the location of the defect to a robot coordinate system;
moving the robot to the location in the robot coordinate system; and repairing the defect with the robot.

2. The method according to claim 1, wherein the camera is aligned with the component before capturing the image.

3. The method according to claim 2, wherein aligning the camera with the component comprises moving the camera to a predetermined position with respect to a feature of the component within the image.

4. The method according to claim 1, further comprising transforming the location of the defect from the image coordinate system to a part coordinate system using a location of a feature of the component located within the image.

5. The method according to claim 1, further comprising transforming the location of the defect from the part coordinate system to the robot coordinate system using a calibration between the camera and the robot.

6. The method according to claim 1, wherein the camera is movable with respect to the component.

7. The method according to claim 6, wherein the camera is moved with respect to the component to capture the image separate from performing the operation.

8. The method according to claim 1, further comprising two of the camera, wherein the image is a 3D image captured by the two cameras.

9. The method according to claim 1, wherein the operation comprises dispensing a bead of material.

10. The method according to claim 9, wherein identifying the location of the defect comprises a determining a width of the bead along a length thereof.

11. The method according to claim 10, wherein determining the width of the bead comprises comparing a number of pixels in the image representing the bead to an expected number of pixels for the bead.

12. The method according to claim 9, wherein repairing the defect comprises dispensing another bead of the material at the location of the defect.

13. The method according to claim 1, wherein the defect comprises a gap in the operation along a length thereof.

14. The method according to claim 1, further comprising determining if the defect is repairable with the robot before repairing the defect with the robot, and flagging the component for manual repair if the defect is determined to be not repairable by the robot.

15. The method according to claim 14, wherein a number of defects is counted, the component being determined to be not repairable by the robot if the number of defects exceeds a threshold number.

16. The method according to claim 1, wherein locations of a plurality of defects are identified and grouped together in a batch, a batch repair instruction being sent to the robot to repair the plurality of defects.

17. The method according to claim 1, wherein locations of a plurality of defects are identified as being a contiguous section, a start location and an end location being determined for the contiguous section, and the plurality of defects being repaired by the robot in a uniform operation between the start location and the end location.

18. The method according to claim 1, wherein the defect is repaired by moving the robot to the location of the defect in the robot coordinate system without following a path of the operation.

19. The method according to claim 1, further comprising identifying locations of defects of the operation from a plurality of components, and transforming the location of each defect from the image coordinate system to a part coordinate system of each component, and tabulating the locations of the defects from the plurality of components in the part coordinate system of each component.

20. The method according to claim 1, wherein repairing the defect with the robot comprises identifying a robot instruction used to perform the operation at the location of the defect, and performing another operation with the robot based on the identified robot instruction.
